(19) United States
(12) Patent Application Publication
(10) Pub. No.: US 2016/0307305 A1
(43) Pub. Date: Oct. 20, 2016

(54) COLOR STANDARDIZATION FOR DIGITIZED HISTOLOGICAL IMAGES

(71) Applicant: RUTGERS, THE STATE UNIVERSITY OF NEW JERSEY, New Brunswick, NJ (US)

(72) Inventors: Anant Madabhushi, Shaker Heights, OH (US); Ajay Basavanhally, Piscataway, NJ (US); Andrew Janowczyk, East Meadow, NY (US)

(73) Assignee: RUTGERS, THE STATE UNIVERSITY OF NEW JERSEY, New Brunswick, NJ (US)

(21) Appl. No.: 15/030,972

(22) PCT Filed: Oct. 23, 2014
(86) PCT No.: PCT/US14/62070

§ 371 Date: Apr. 21, 2016

Related U.S. Application Data
(60) Provisional application No. 61/894,688, filed on Oct. 23, 2013.

(51) Int. Cl. G06T 5/40; G06K 9/46; G06T 5/50; G06K 9/62; G06T 7/00; G06T 3/00

(52) U.S. Cl. CPC G06T 5/40; G06T 7/0081; G06T 7/0087; G06T 3/0068; G06T 5/50; G06K 9/6259; G06K 9/6218; G06K 9/6212; G06K 9/4652

(57) ABSTRACT

A system is provided for standardizing digital histological images so that the color space for a histological image correlates with the color space of a template image of the histological image. The image data for the image is segmented into a plurality of subsets that correspond to different tissue classes in the image. The image data for each subset is then compared with a corresponding subset in the template image. Based on the comparison, the color channels for the histological image subsets are shifted to create a series of standardized subsets, which are then combined to create a standardized image.

### FIELD OF THE INVENTION

The present invention relates to the field of processing histological images. In particular, the present invention relates to standardizing coloring in histology to reduce color variation among histological images.

### BACKGROUND

The development of computerized image analysis tools (e.g. object segmentation) for digitized histology images is often complicated by color nonstandardness—the notion that different image regions corresponding to the same tissue will occupy different ranges in the color histogram—due to variations in slide thickness, staining, and lighting.

Previous attempts to overcome non-standardness work have often focused on maintaining color constancy in images formed by reflective light such as digital photography, which are inappropriate for histopathology images formed by light absorption. For instance, one method studied color calibration of computer monitors for optimal viewing of digitized histology.

Note that, unlike standardization, color calibration requires access to either the imaging system or viewing device to adjust relevant acquisition or visualization settings. Piecewise intensity standardization has been used for correcting intensity drift in grayscale MRI images, but has been limited to (a) a single intensity channel and (b) global standardization using a single histogram for an image. Previous work has implicitly incorporated basic spatial information via the generalized scale model in MRI images. However, such approaches were directed to a connected component labeling that is not used for tissue classes (e.g. nuclei) spread across many regions.

The act of staining biological specimens for analysis under a microscope has been in existence for over 200 years. The adding of agents, either artificial or natural, changes the chormatic appearance of the various structures they are chosen to interact with. For example, two commonly used agents, Hemotoxylin and Eosin (HE), can cause different chromatic appearance: the hemotoxylin provides a blue or purple appearance to the nuclei while the eosin stains eosinophilic structures (e.g., cytoplasm, collagen, and muscle fibers) a pinkish hue.

Since the staining process is a chemical one, there are many variables which can drastically change the overall appearance of the same tissue. For example, the concentration of the stain, manufacturer, time, and temperature the stain is applied all have significant implications on the final specimen. FIG. 6, shows a number of HE stained gastrointestinal (GI) samples. The samples are sample taken from the same specimen but stained using slightly different protocols, and as such, there is significant variation among the samples even though they are all from the same specimen.

The staining process is not the only source of visual variability in histo-pathology imaging. The digitalization process also produces variance. One would expect that since the tissue is the same, the visual appearance would be the same, but this is not always the case due to differences in equipment manufacturing (e.g., bulbs, CCD, etc) and acquisition technologies (e.g., compression, tiling, whiteness correction, etc).

While human pathologists are specifically trained to be able to mitigate these differences and typically do not struggle with performing mental correction, algorithms used to create computer aided diagnostic (CAD) pipelines to data mine large datasets are indeed sensitive to these visual changes. This is problem is compounded when processing extremely large datasets that are curated from many different facilities, such as those found in the The Cancer Genome Atlas (TOGA).

### SUMMARY OF THE INVENTION

In light of the foregoing, the present invention provides a method for standardizing histological images to account for color variations in the images due to the staining protocol or scanning process.

According to one aspect, the invention provides a method for processing histological images to improve color consistency that includes the steps of providing image data for a histological image and selecting a template image comprising image data corresponding to tissue in the histological image, wherein the template comprises a plurality of data subsets corresponding to different tissue classes in the template. The image data for the histological image is segmented into a plurality of subsets, wherein the subsets correspond to different tissue classes. A histogram for each data subset of the template is constructed and a histogram for the corresponding subset of the image data for the histological image is constructed. The histogram for each subset of the image data is aligned with the histogram of the corresponding data subset of the template to create a series of standardized subsets of the image data. The standardized subsets of the image data are then combined to create a standardized histological image.

According to another aspect of the invention, a method for processing histological images to improve color consistency is provided, which includes the steps of providing image data for a histological image and selecting a template corresponding to the histological image, wherein the template comprises a plurality of data subsets corresponding to different tissue classes in the template and each data subset is divided into a plurality of color channels. The image data for the histological image is segmented into a plurality of subsets, wherein the subsets correspond to different tissue classes and each subset of image data is divided into a plurality of color channels. The histological image data of each color channel in a subset is compared with the corresponding data subset of the corresponding color channel for the template. The histological image data of each color channel in a subset is selectively varied in response to the step of comparing to create a series of standardized subsets of the image data. The standardized subsets of the image data are then combined to create a standardized histological image.

According to yet another aspect of the invention, a method for processing histological images to improve color consistency is provided. The method includes the step of selecting a template histological image, wherein the template comprises a plurality of data subsets corresponding to different tissue classes in the template and each data subset is divided into a plurality of color channels. A number of the data subsets are randomly selected and unsupervised deep learning filters are trained on the randomly selected subsets. The deep learning filters are applied to a histological image to produce a set of filtered image data. The filtered image data is segmented into a plurality of subsets and the filtered image data subsets are compared with the corresponding data subset for the template. The histological image data of each color channel in a subset is selectively varied in response to the step of comparing to create a series of standardized subsets of the image data and the standardized subsets of the image data are combined to create a standardized histological image.

### DESCRIPTION OF THE DRAWINGS

The foregoing summary and the following detailed description of the preferred embodiments of the present invention will be best understood when read in conjunction with the appended drawings, in which:

FIG. 1 is a schematic illustration of a system for processing data for a histological image according to a methodology employing expectation maximization;

FIG. 2(a)-(c) is a series of histograms illustrating the distributions of the color channels for all images in a prostate cohort. In each figure, the histogram of the template image is represented by a thick black line.

FIG. 2(a) is a histogram illustrating non-standardized images having unaligned histograms due to intensity drift;

FIG. 2(b) is a histogram illustrating GS processing providing improved histogram alignment;

FIG. 2(c) is a histogram illustrating EMS processing providing improved results over both (a) and (b).

FIG. 3(a)-(h) is a series of H & E stained histopathology images corresponding to prostate tissue in FIGS. 3(a)-3(d) and oropharyngeal cancers in FIGS. 3(e)-3(h).

FIGS. 3(a) and (e) provide images in which nuclei in template images are segmented (outline) using an empirically-selected intensity threshold (less than 115 and 145, respectively, for the two cohorts);

FIGS. 3(b) and (f) provide images in which the same threshold does not provide consistent segmentation in a non-standardized test image due to intensity drift (i.e. nonstandardness);

FIGS. 3(c) and (g) provide images processed using GS to improve consistency;

FIGS. 3(d) and (h) provide images processed using EMS to yield in additional improvement;

FIGS. 4(a)-(f) is a series of image segments from an image template and a moving image;

FIG. 4(a) is an image segment of an image template;

FIG. 4(b) is the image segment of FIG. 4(a) after application of an arbitrarily selected deep learning filter;

FIG. 4(c) is the image segment of FIG. 4(a) after the application of an arbitrarily selected deep learning filter;

FIG. 4(d) is an image segment of a moving image;

FIG. 4(e) is the image segment of FIG. 4(d) after application of the deep learning filter used in FIG. 4(b);

FIG. 4(f) is the image segment of FIG. 4(d) after application of the deep learning filter used in FIG. 4(c);

FIG. 5(a)-(d) is a series of image segments from an image template and a moving image;

FIG. 5(a) is an image segment from an image template after filtering;

FIG. 5(b) is an illustration of the image segment of FIG. 5(a) after clustering the pixels of the image segment;

FIG. 5(c) is an image segment from a moving image after filtering;

FIG. 5(d) is an illustration of the image segment of FIG. 5(c) after clustering the pixels of the image segment, wherein the pixels in the moving image are assigned to the closest cluster created in the template image;

FIG. 6 is a series of images of seven slices from a single tissue sample wherein each image was stained according to a different protocol;

FIGS. 7(a)-(c) is a series of whisker plots showing the differences between images scanned using the same scanner, wherein the dashed line indicates the mean, the box bounds the 25th percentile and the whiskers extend to the 75th percentile, the dots above or below the whiskers identifyoutliers;

FIG. 7(a) illustrates a comparison of a first batch of images scanned on a Ventana scanner compared against a second batch of images scanned on the Ventana scanner;

FIG. 7(b) illustrates a comparison of the first batch of images scanned on the Ventana scanner compared against a third batch of images scanned on the Ventana scanner;

FIG. 7(c) illustrates a comparison of the second batch of images scanned on the Ventana scanner compared against the third batch of images scanned on the Ventana scanner;

FIGS. 8(a)-(c) is a series of whisker plots showing the differences between images scanned using different scanners, wherein the dashed line indicates the mean, the box bounds the 25th percentile and the whiskers extend to the 75th percentile, the dots above or below the whiskers identify outliers;

FIG. 8(a) illustrates a comparison of a batch of images scanned on a Leica scanner compared against the first batch of images scanned on the Ventana scanner;

FIG. 8(b) illustrates a comparison of the batch of images scanned on a Leica scanner compared against the second batch of images scanned on the Ventana scanner;

FIG. 8(c) illustrates a comparison of the batch of images scanned on a Leica scanner compared against the third batch of images scanned on the Ventana scanner;

FIG. 9 illustrates a series of images before and after the color standardization process, wherein the upper row illustrates a first image stained according to an HE process and a second image stained according to an HE process; the middle row shows the first image normalized against the second image and the second image normalized against the first image; the bottom row shows the first and second images normalized against a standard image;

FIGS. 10(a)-(b) illustrate the results when the template image has significant class proportionality than the moving image;

FIG. 10(a) is a moving image;

FIG. 10(b) is a template image having a section of red blood cells not present in the moving image; and

FIGS. 11(a)-(b) are Whisker plots showing Dice coefficient before normalization (column 1), after global normalization (column 2) and after a DL approach (column 3). wherein the dashed line indicates the mean, the box bounds the 25th percentile and the whiskers extend to the 75th percentile, the dots above or below the whiskers identifyoutliers.

### DETAILED DESCRIPTION OF THE INVENTION

1. Processing Images Using Expectation Maximization Scheme

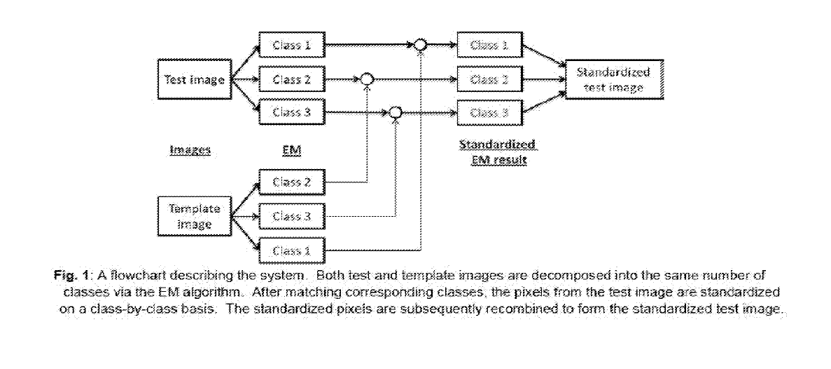

A first system for processing digital histological images is illustrated generally in FIG. 1. The system addresses color variations that can arise from one or more variable(s), including, for example, slide thickness, staining variations and variations in lighting. In the following discussion it should be understood that histology is meant to include histopathology.

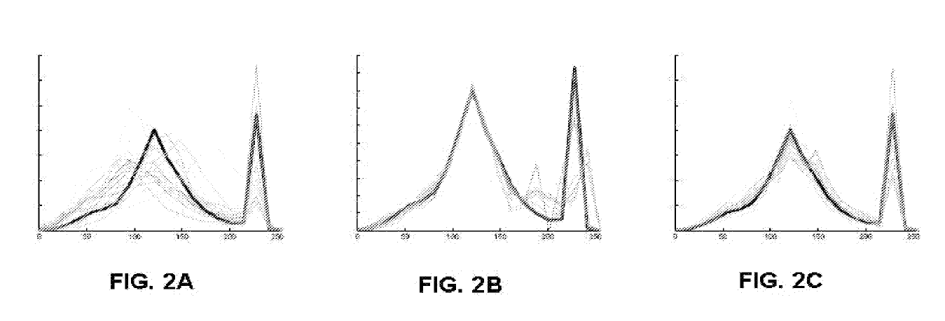

The recent proliferation of digital histopathology in both clinical and research settings has resulted in (1) the development of computerized image analysis tools, including algorithms for object detection and segmentation; and (2) the advent of virtual microscopy for simplifying visual analysis and telepathology for remote diagnosis. In digital pathology, however, such tasks are complicated by color nonstandardness (i.e. intensity drift)—the propensity for similar objects to exhibit different color properties across images—that arises from variations in slide thickness, staining, and lighting variations during image capture (FIG. 2(a)).

Color standardization aims to improve color constancy across a population of histology images by realigning color distributions to match a pre-defined template image. Frequently, Global standardization (GS) approaches are insufficient because histological imagery often contains broad, independent tissue classes (e.g. stroma, epithelium, nuclei, lumen) in varying proportions, leading to skewed color distributions and errors in the standardization process (See FIG. 2(b)). Accordingly, the following discussion describes an Expectation Maximization (EM) based color standardization scheme (EMS) that improves color constancy across histology images in a single tissue type (See FIG. 2(c)).

Nonstandardness (i.e. intensity drift) can be addressed via standardization, which aims to improve color constancy by realigning color distributions of images to match that of a pre-defined template image. Color normalization methods attempt to scale the intensity of individual images, usually linearly or by assuming that the transfer function of the system is known. In contrast, standardization matches color levels in imagery across an entire pathology irrespective of the institution, protocol, or scanner. Histopathological imagery is complicated by (a) the added complexity of color images and (b) variations in tissue structure. Accordingly, the following discussion presents a color standardization scheme (EMS) to decompose histological images into independent tissue classes (e.g. nuclei, epithelium, stroma, lumen) via the Expectation Maximization algorithm and align the color distributions for each class independently. In contrast to the EMS scheme, global standardization (GS) methods attempt to align histograms of the entire image and do not account for the heterogeneity created by varying proportions of different tissue classes in each image.

As discussed further below, prostate and oropharyngeal histopathology tissues from 19 and 26 patients, respectively, were evaluated. In a comparison of normalized median intensities, EMS produces lower standard deviations (i.e. greater consistency) of 0.0054 and 0.0030 for prostate and oropharyngeal cohorts, respectively, than non-standardized (0.034 and 0.038) and GS (0.0305 and 0.0175) approaches.

Referring again to FIG. 1, EMS is used to improve color constancy across multiple prostate and oropharyngeal histopathology images (See FIG. 2(c)). First, the EM algorithm is used to separate each image into broad tissue classes (e.g. nuclei, stroma, lumen), mitigating heterogeneity caused by varying proportions of different histological structures. Histograms are constructed using pixels from each tissue class of a test image and aligned to the corresponding tissue class in the template image. For comparison, evaluation is also performed on images with GS whose color distributions are aligned directly without isolating tissue classes (FIG. 2(b)).

Accordingly, the present system provides an EM-based color standardization scheme (EMS) for digitized histopathology that:

aligns color distributions of broad tissue classes (e.g. nuclei, stroma) that are first partitioned via EM; (by contrast, previous global methods perform standardization using a histogram of the entire image);

can be used retrospectively since EMS is independent of scanners, staining protocols, and institutions; and

can easily be extended to other color spaces beyond the RGB space.

Method for Implementing Expectation Maximization Scheme

In the present system, an image scene Cₐ=(C, f) is a 2D set of pixels c ∈ C and f is the associated intensity function.

Global Intensity Standardization for Color Images

Global standardization (GS) of color images deforms the histogram of each RGB channel from a test image scene Cₐ to match a template image scene C_{b} via a piecewise linear transformation (See FIG. 2(b)). Algorithm 1 set forth below represents an extension of standardization for a single intensity channel.

Class-Specific Color Standardization using the EM Framework

Tissue-specific color standardization (FIG. 2(c)) extends GS by using the Expectation Maximization (EM) algorithm to first partition histopathology images into broad tissue classes (Algorithm 2 set forth below).

Algorithm 1 GlobalStandardization(GS)

```
  Input: Template image C_{b}. Test image Cₐ to be standardized.
Output: Standardized image Ĉₐ.
  1: for RGB channels i ∈ {R,G,B} in Cₐ and C_{b} do
  2: Define histograms Hᵢ^{a} and Hᵢ^{b} for all pixels in
respective RGB channels for Cₐ and C_{b}.
  3: Let {rₘᵢₙ, r₁₀, r₂₀, . . . , r₉₀, rₘₐₓ} and
  {sₘᵢₙ, s₁₀, s₂₀, . . . , s₉₀, sₘₐₓ} be landmarks at
the minimum and maximum pixel values, as well as evenly-
spaced percentiles {10, 20, . . . , 90} in Hᵢ^{a} and Hᵢ^{b} respectively.
  4: Map pixel values from [rₘᵢₙ, r₁₀] to match pixel values
from [sₘᵢₙ, s₁₀]. Repeat mapping process for all sets of
adjacent landmarks.
5: end for
6: Recombine standardized RGB channels to construct
standardized image Ĉₐ.
```

Algorithm 2 EMbasedStandardization(EMS)

```
  Input: Template image C_{b}. Test image Cₐ to be standardized.
Number of EM components κ.
  Output: Standardized image C′ₐ.
1: Apply EM algorithm to separate pixels from both Cₐ and C_{b}
into κ tissue classes.
2: for K ∈ {1, 2, . . . , κ} do
3: Let Cₐ^{K} ⊂ Cₐ and C_{b}^{K} ⊂ C_{b} correspond to sub-scenes from
the test and template images corresponding to EM component K.
4: Perform GlobalStandardization( ) using Cₐ^{K} and C_{b}^{K}
as test and template images, respectively (Alg. 1).
5: end for
6: Create standardized image C′ₐ = {Cₐ^{K} : ∀K ∈ {1, 2, . . . κ}} by
recombining standardized sub-scenes from all κ components of the
test image.
```

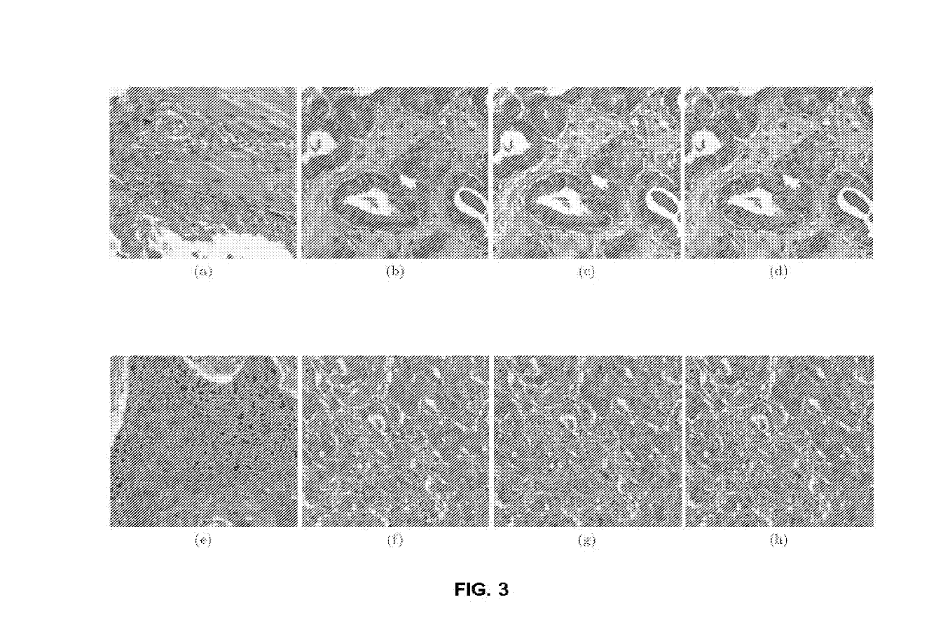

Information about both prostate and oropharyngeal cohorts is summarized below in Table 1. In terms of normalized median intensity (NMI), EMS produces improved color constancy compared to the original images, with considerably lower NMI standard deviation (SD) of 0.0054 vs. 0.0338 and NMI coefficient of variation (CV) of 0.0063 vs. 0.0393 in the prostate cohort (Table 2). In addition, EMS is more consistent than GS, which yields SD of 0.0305 and CV of 0.0354. All corresponding results for the oropharyngeal cohort show similar improvement after standardization. Further, the improvement seen through EM-based separation of tissue classes suggests that EMS may be vital to the development of algorithms for the segmentation of primitives (e.g. nuclei). These improvements are also reflected in FIGS. 3(a)-3(h).

TABLE 1
A description of the prostate and oropharyngeal data cohorts used.

| Cohort | # images | Staining | Resolution | Size |
|---|---|---|---|---|
| Prostate | 19 | Hematoxylin & | 1 μm/pixel | 500 × 500 |
| Oropharyngeal | 26 | eosin | | pixels |

As shown below in Table 2, the standard deviation (SD) and coefficient of variation (CV) for the normalized median intensity (NMI) of a histological image is lower using the EMS methodology described above. In Table 2 the SD and CV are calculated for each image in the prostate and oropharyngeal cohorts. The NMI of an image is defined as the median intensity value (from the HSI color space) of all segmented pixels, which are first normalized to the range [0, 1]. NMI values are expected to be more consistent across standardized images, yielding lower SD and CV values.

TABLE 2
Standard deviation (SD) and coefficient of variation (CV) of normalized
median intensity (NMI) for prostate and oropharyngeal cohorts.

| | |
|---|---|
| Prostate | Oropharyngeal |

| | SD | CV | SD | CV |
|---|---|---|---|---|
| Original | 0.0338 | 0.0393 | 0.0380 | 0.0442 |
| GS | 0.0305 | 0.0354 | 0.0175 | 0.0204 |
| EMS | 0.0054 | 0.0062 | 0.0030 | 0.0034 |

With the rapid growth of computerized analysis for digital pathology, it is increasingly important to address the issue of color nonstandardness that result from variations in slice thickness, staining protocol, and slide scanning systems. In addition, a robust approach to color standardization will benefit the burgeoning virtual microscopy field by providing clinicians with more consistent images for visual analysis. In the above description, a color standardization scheme is provided that (1) does not require information about staining or scanning processes and (2) accounts for the heterogeneity of broad tissue classes (e.g. nuclei, stroma) in histopathology imagery. Both quantitative and qualitative results show that EMS yields improved color constancy over both non-standardized images and the GS approach. Although the methodology is described above in connection with prostate and oropharyngeal tissue, the methodology is applicable to other tissue as well, including larger cohorts. The methodology may also incorporate spatial information to improve separation of tissue classes.

2. Deep Learning Filters Scheme

The Expectation Maximization Scheme uses pixel clustering to provide an approximated labeling of tissue classes. Using these individual clusters the color values can be shifted so that the moving image matched the template image. In addition to the Expected Maximization Scheme described above, a separate process for normalizing digital histopathology images will now be provided. The Deep Learning Filter Scheme extends upon the Expectation Maximation Scheme by the addition of a fully unsupervised deep learned bank of filters. Such filters represent improved filters for recreating images and allow for obtaining more robust pixel classes that are not tightly coupled to individual stain classes.

The following discussion is broken down into several sections. First, a description of the algorithms and methods used in the Deep Learning Filter Scheme is provided. The scheme is then evaluated across 2 different datasets. The results of those evaluations are then discussed.

The Deep Learning Filter Scheme exploits the fact that across tissue classes, and agnostic to the implicit differences arising from different staining protocols and scanners, as described above, deep learned filters produce similar clustering results. Afterwards by shifting the respective histograms on a per cluster, per channel basis, output images can be generated that resemble the template tissue class. As such, this approach simply requires as input a template image, as opposed to domain specific mixing coefficients or stain properties, and successfully shifts a moving image in the color domain to more accurately resemble the template image.

In the following description, the dataset Z={C₁, C₂ . . . C_{M}} of M images, where an image C=(C, ψ) is a 2D set of pixels c ∈ C and is the associated function which assigns RGB values. T=Cₐ ∈ Z is chosen from Z as the template image to which all other images in the dataset will be normalized. Without loss of generality S=C_{b} ∈ Z is chosen to be the “moving image”, which is to be normalized into the color space of T. In other words, a moving image is an image to be standardized against another image, which in the present instance is a template image. Matricies are capitalized, while vectors are lower case. Scalar variables are both lower case and regular type font. Dotted variables, such as \dot{T}, indicate the feature space representation of the variable T, which has the same cardinality, though the dimensionality may be different.

Deep Learning of Filters from Image Patches

Autoencoding is the unsupervised process of learning filters which can most accurately reconstruct input data when transmitted through a compression medium. By performing this procedure as a multiple-layer architecture, increasingly sophisticated data abstractions can be learned, motivating their usage in deep learning style autoencoders. As a further improvement, it was found that by perturbing the input data with noise and attempting to recover the original unperturbed signal, an approach termed denoising auto-encoders, resulted in increasingly robust features. These denoising auto-encoders are leveraged in the present system.

1) One Layer Autoencoder: From T, p ∈ R^{v'v×3} sub-images, or patches are randomly selected. The patches are of v×v dimension in 3-tuple color space (RGB). To simplify notation, V is set so that V=v ·v·3 to simplify notation. These values are reshaped into a data matrix X ∈R^{p×v} of x ∈ R^{1×V} samples. This matrix forms the basis from which the filters will be learned.

A simple one layer auto-encoder can be defined as having both an encoding and decoding function. The encoding function encodes a data sample from its original dataspace of size V to a space of size h. Consequently, the decoding function decodes a sample from h space back to V space.

The notation used herein shows a typical encoding function for a sample x is

V=f₀(x)=s(Wx+b) (1)

parameterized by θ={W, b}. W is a h×V weight matrix, b ∈ R^{1,v} is a bias vector, and s is an activation function (which will be assumed to be the hyperbolic tangent function). The reconstruction of x, termed z, proceeds similarly using a decoding function z=g_{θ′}(y)=s(W′y+b′) with θ′={W′b′}. Here W′ is a V×h weight matrix, and b ∈ R^{1,v}; h is again a bias vector.

A stochastic gradient descent is used to optimize both θ and θ′ relative to the average reconstruction error. This error is defined as:

$${θ}^{*} , {θ}^{′ *} = arg {min}_{θ , {θ}^{′}} \frac{1}{p} {\sum }_{i = 1}^{p} L ( {x}^{( i )} , {z}^{( i )} ) \qquad ( 2 )$$

Where the loss function L is a simple squared error L(x, z)=∥X−z∥².

2) Expansion to Multiple Layers and Denoising: By applying these auto-encoders in a greedy layer-wise fashion, higher level abstractions, in a lower dimensional space, are learned. In particular, this means taking the output from layer ;, i.e., y^{l}, and directly using that as the input (x^{(l+1)}t the next layer to learn a further abstracted output y^{(l+1)} by re-applying Equation 2. To further couple the annotation, Layer 1 has input x⁽¹⁾ of size R^{1×V} and output y⁽¹⁾ of sizeR^{1×h}^{⁽¹⁾}. Layer 2 thus has x⁽²⁾=y⁽¹⁾ of size R^{1×h}^{⁽¹⁾} and output y⁽²⁾ of size R^{1×h}^{⁽²⁾}. This layering can continue as deemed necessary.

Additionally, by intentionally adding noise to the input values of X, more robust features across all levels can be learned. Briefly, in the present instance, \hat{X}=ε(X) where ε is a binomial corrupter which sets elements in X to 0 with probability φ. Using \hat{x} in place of x in Equation 1, results in the creation of a noisy lower dimensional version \hat{z}. This reconstruction is then used in Equation 2 in places of z, while the original x remains in place. In general, this attempts to force the system to learn robust features which can recover the original data, regardless of the intentionally added noise, as a result of decorrelating pixels.

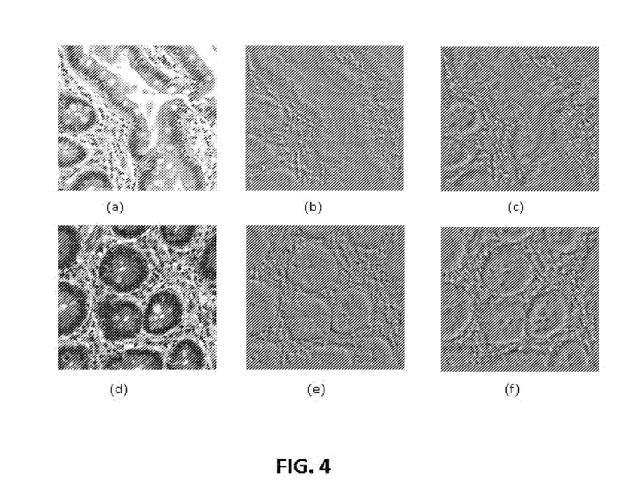

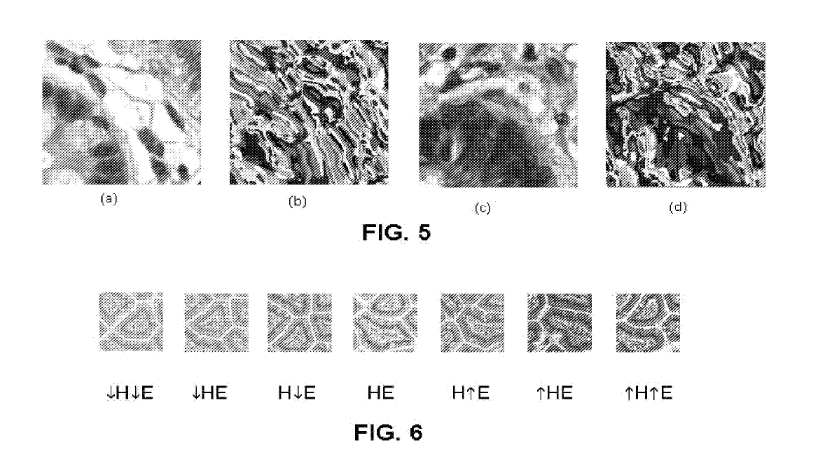

3) Application to Dataset: Once the filters are learned for all levels (an example of level 1 is shown in FIG. 4), the full hierarchy of encoders are applied on both the template image, T, and a “moving image”, S. An assumption of the present approach is that regardless of visual appearance, underlying pixels of the same physical entities will respond similarly to the learned filters. FIG. 5 shows an example of this using two images of the same tissue stained with different protocols. It can be seen that although the visual appearance of these two images is quite different, the filters appear to identify similar regions in the image. Therefore, it can be seen that the deep learning does a good job of being agnostic to staining and image capturing fluctuations and thus can be used as the backbone for a normalization process.

### Deep Learning Filters Algorithm 1

Acquiring and Applying Deep Learning Filters

Input: A template image , a moving image S, patch matrix X,
number of levels L, architecture configuration h
Output: \dot{T}∈ R^{|T|×h}^{^{(L)}} , \dot{S}∈ R^{|S|×h}^{^{(L)}}
1: \dot{T}= ψ(c),∀c ∈ (T)
2: \dot{S}= ψ(c),∀c ∈ (S)
3: for l = 1 to L do
4: Find θ^{(l)}*,θ′^{(l)}* using Equation 2
5: X = f_{θ(l)} * (X)
6: \dot{T}= f_{θ(l)} * (\dot{T})
7: \dot{S}= f_{θ(l)} * (\dot{S})
8: end for
9: return \dot{T}, \dot{S}

C. Unsupervised Clustering

Once obtained, the filter responses for T and S, i.e., \dot{T} and \dot{S} respectively, they are clustered into subsets so that each partition can be treated individually. To this end, a standard k-means approach is employed on \dot{T} to identify K cluster centers. Afterwards, each of the pixels in \dot{S} is assigned to its nearest cluster, without performing any updating. Algorithm 2 below provides an overview of this process.

In previous approaches, these K clusters loosely corresponded to individual tissue classes such as nuclei, stroma or lymphocytes. The maximum number K was implicitly limited since each of the color values had no additional context besides it chromatic information. In the case of the present approach, a much larger K is used, on the order of 50. These classes are not comparable to individual classes as shown in FIG. 4, but instead are highly correlated to the local texture present around the pixel, provided much needed context. The larger number, and more precisely tuned, clusters, afford the opportunity for greater normalization in the histogram shifting step.

### Deep Learning Filters Algorithm 2

Cluster Images in Filter Space

Input: \dot{T}, \dot{S}, number of clusters K
Output: T° ,S°, cluster indicator variables
1: Using k-means with \dot{T}, identify K clusters with μᵢ i ∈ {1, ..., K}
as their centers
2: T° = {arg minᵢ ||c − μ||²:∀c ∈ \dot{T},i ∈ {1, ..., K}}
3: S° = {arg minᵢ ||c − μ||²:∀c ∈ \dot{S},i ∈ {1, ... , K}}
4: return T°, S°

D. Histogram Shifting

Once the clusters are defined, a more precise normalization process can take place. On a per cluster, per channel bases, the cumulative histograms are normalized to the template image. This approach is presented in Algorithm 3 which is the bases for the implementation of the imhistmatch function in Matlab.

### Deep Learning Filters Algorithm 3

Shifting Histograms for Normalization

Input: \dot{T}, T°, \dot{S}, S°, K, number of bins Q
Output: final normalized image \tilde{S}
1: for k = 1 : K do
2: \hat{T} = subset of T which has T° = k
3: Ŝ = subset of S which has S° = k
4: for h = {R, G, B} do
5: f_{T} = CumulativeSum(φ_{\hat{T},}•ₕ(\hat{T}),Q)
6: f_{S} = CumulativeSum(φ_{Ŝ,}•ₕ(Ŝ),Q)
7: Δ is a function which minimizes |fₛ(Δ(q)) − f_{T}(q)|∀q ∈ {1, ..., Q}
8: φ_{S,}•ₕ(Ŝ) = Δ(Ŝ)
9: end for
10: end for
11: return R(q)

One of the benefits of over segmenting the image, into a larger number of groups than there are inherit tissue classes, is that extreme values have lesser impact on the normalization process because their contribution is minimal. Additionally, with larger differentiation between clusters, there is greater specificity in the alignment of the groups, allowing for a finer tuned result.

As discussed below, a common problem with global normalization techniques is the inability to account for both tissue class proportions and in cases where the histograms are already similar, bringing the overall error down (see Example 1 below). In the present scheme, by assigning the pixels in S to a larger number of clusters, but not performing updating, the disproportionality is managed. In the extreme case, when there are no pixels in cluster k ∈ {1, . . . , K}, the normalization has no effect, resulting in only highly correlated smaller clusters having an effect on the end result.

### EXAMPLES

To evaluate the Deep Learning Filter Scheme discussed above, three experiments were performed, each designed to examine an area of importance in standardization: (a) equipment variance, (b) protocol variance, and (c) improved pipeline robustness. Using three different datasets, as shown in Table 3, which were specifically manufactured to directly quantitatively evaluate the present approach, the improvements afforded by the present approach was demonstrated as compared to five other approaches.

TABLE 3
Presentation of Various Datasets Used in Examples

| Name | Organ | Stain | Resolution | Importance |
|---|---|---|---|---|
| S₁ | Breast | HE | 40x | Same Slides scanned on different |
| | | | | equipment |
| S₂ | GI | HE | 40x | Adjacent slices stained using |
| | | | | different protocols |
| S₃ | GI | HE | 40x | A subset of S₂ containing manual |
| | | | | annotations of nuclei boundaries |

### A. Datasets

1) Dual Scanner Breast Biopsies: The S1 dataset consists of 5 breast biopsies slides. Each slide was scanned at 40× magnification 3 times on a Ventana whole slide scanner and one time on a Leica whole slide scanner, resulting in 20 images of about 100,000×100,000 pixels. Each set of 4 images (i.e., 3 Ventana and 1 Leica), were mutually co-registered so that from each biopsy set, 10 sub-regions of 1,000×1,000 could be extracted. This resulted in 200 images: 10 sub-images from 4 scans across 5 slides. The slide contained samples positive for cancer which were formalin fixed paraffin embedded and stained with Hematoxylin and Eosin (HE). Since the sub-images were all produced from the same physical entity, the images allowed for a rigorous examination of intra- and inter-scanner variabilities. Examples of the images can be seen in FIG. 5.

2) Gastro-Intestinal Biopsies of differing protocols: The S₂ dataset consists of slices taken from a single cancer positive Gastro Intestinal (GI) biopsy. The specimen was formalin fixed paraffin embedded and had 7 adjacent slices removed and subjected to different straining protocols: HE, H↓E, H↑E, ↓HE, ↓H↓E, ↑HE and ↑H↑E, where ↑ and ↓ indicate over- and under-staining of the specified dye. These intentional staining differences are a surrogate for the typical variability seen in clinical settings, especially across facility. Each slide was then digitized using an Aperio whole-slide scanner at 40× magnification (0.25 μm per pixel), from which 25 random 1,000×1,000 resolution images were cropped at 20× magnification. Examples of the images can be seen in FIG. 6.

3) Gastro-Intestinal Biopsies of differing protocols with annotations: The S₃ dataset is a subset of the S₂ dataset which contains manual annotations of the nuclei. From each of the 7 different protocols, as discussed above, a single sub image of about 1,000×1,000 pixels was cropped at 40× magnification and exact nuclei boundaries were delineated by a person skilled at identifying structures in a histological specimen.

### B. Algorithms

1) DL Normalization: The parameters associated with the configuration of the Deep Learning Filter approach referred to as Deep Leaning Standardization (DLSD) are as follows: 250,000 patches of size (v) 32×32, were used. A 2-layer Sparse Autoencoder (SAE) was created with the first layer containing 100 hidden nodes (h₁) and the second layer containing ten (h₂). The denoising variable was set to ε=0.2. Histogram equalization took place using Q=128 bins. Additionally, preprocessing steps were used, including: ZCA whitening and global contrast normalization.

It took 5 hours to train the deep learning network using a Nvidia M2090 GPU with 512 cores at 1.3 ghz and under 3 minutes to generate each output image needed for the clustering mechanism. Afterwards, for images of size 1,000×1,000 the entire clustering and shifting process takes under 1 minute on a 4 core 2.5 ghz laptop computer. All deep learning was developed and performed using the popular open source library Pylearn2 which uses Theano for its backend graph computation.

2) Raw: The Raw used the raw image without any modifications to quantify what would happen if no normalization process was undertaken at all.

3) Global Standardization: To evaluate the benefit to the DLSD approach, a naive global standardization (GL) technique was also utilized. This proceeds similarly to Algorithm 3, except assuming that K=1, in which all pixels in the image belong to a singular cluster. This provides a quantitative metric within which to show the benefit of sub-dividing the image into deep learning based clusters as it does not account for any types of heterogeneous tissue structure. Again, Q=128 bins were used for the histogram matching process.

4) Four Additional Approaches: The results were also compared against a publicly available stain normalization toolbox. This toolbox contributes results from four additional approaches. The first toolbox approach is a Stain Normalization approach using RGB Histogram Specification Method—Global technique and is abbreviated in this description and the figures as “HS”. The second toolbox approach is abbreviated in this description and the figures as “RH” and is described in the publication entitled Color transfer between images. IEEE Computer graphics and applications, 21(5):34-41 published in 2001 by Reinhard, Ashikhmin, Gooch, & Shirley. The third toolbox approach is abbreviated in this description and the figures as “MM” and is described in the publication entitled A Method for Normalizing Histology Slides for Quantitative Analysis. ISBI, Vol. 9, pp. 1107-1110, published in June 2009 by Macenko, Niethammer, Marron, Borland, Woosley, Guan, Schmitt & Thomas. The fourth toolbox approach is abbreviated in this description and the figures as “DM” and is described in the publication entitled A nonlinear mapping approach to stain normalisation in digital histopathology images using image-specific colour deconvolution. IEEE Transactions on Biomedical Engineering, 61(6):1729-1738, published in 2014 by Khan, Rajpoot, Treanor & Magee.

C. Experiment 1: Standardization Across Intra/Inter Equipment

1) Design: The first experiment measured how much difference there is between intra-scanner samples and to determine if the DLSD scheme brings the inter-scanner error down into the intra-scanner range. Using the 50 sets of images from dataset S1, two experiments were performed. First, the intra-scanner variance was computed across the 3 Ventana scans and DLSD was applied to determine if it reduced variance on intra-scanner images. Second, an image from a Leica scan was co-registered to align the image data with the image data from the Ventana scans, measuring the error before and after DLSD performed. From here, the benefits of applying DLSD on intra/inter scanner samples is evaluated.

While it may be desirable to perform a pixel level mean squared error, there are two confounding issues (a) the resolution between scanners is not identical, indicating that interpolation would need to occur, causing another source of error and (b) there are visible tiling artifacts visible on both the intra/inter scanner images making an exact error measure unreasonable or impossible.

Instead, with the registered images, for each color channel a 128 bin histogram is computed and the sum of the squared difference of the bins is used for each of the color channels. The optimal error would of course be 0 if both images were exactly the same, but this is rarely seen when capturing images, even using the same scanner, as examined below.

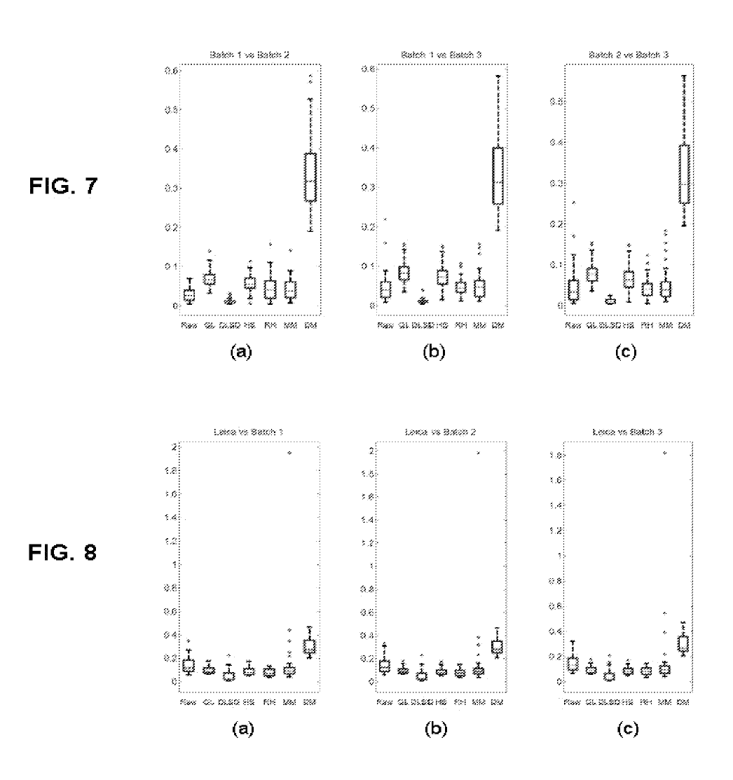

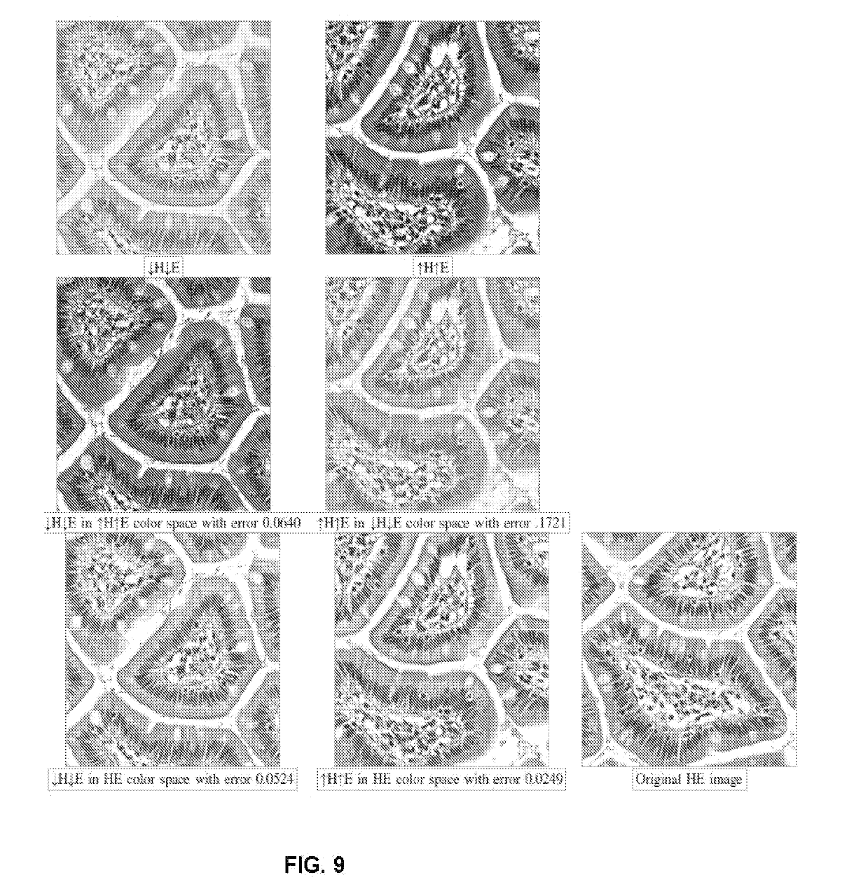

2) Results: After comparing intra-scanner error, it is noted that the mean error is about 0.03 (see FIG. 7). The global normalization seems to fail in this instance because the histogram distributions are already too similar that the normalization technique may add in error rather than removing it. On the other hand, the DLSD approach is not only reduces the mean (0.01) but also greatly compensate for the variance seen within samples. This is a strong indication that the DLSD procedure applied to intra-scanner image captures produces more consistent results.

Similarly, the inter scanner difference is examined (see FIG. 8). In this instance, the global normalization technique does reduce the mean error from about 0.14 to 0.096, but the DLSD approach can be seen to further reduce the error down to 0.047 which is on the order of the raw intra scanner error as shown by FIG. 7 which has a mean error of 0.0473. This result is potentially very useful, as it indicates that using the DLSD method can reduce interscanner variability into intra-scanner range, a standard which is difficult to improve upon. It is expected that these inter-scanner variabilities will be slightly larger than intra-scanner due to the different capturing devices, magnifications, resolutions and stitching techniques.

D. Experiment 2: Standardization Across Stain Protocols

1) Design: One of the sources of unstandardized images is due to staining protocols. Facilities need not (a) use the same manufacturer for their dyes, (b) apply similar timings or (c) use identical stain concentrations. While these differences are typically ignored by human experts, algorithms (especially those relying on thresholding) tend to struggle. The second experiment was directed to determining how well the DLSD approach can succeed at minimizing these errors by bringing images into a common color space as defined by a template image.

In this experiment, the S₂ dataset was used as a way to quantify, using again the error described in Experiment 1, how well the error can be reduced across different staining protocols. In each instance an image from the group was used as a template image and attempt to standardize the remaining 6 images to that image and compute the errors. This was done for all protocol pairings and images: 7 protocols versus the remaining 6 with 25 images each resulting in 1,050 normalization operations. Both mean and variance across all protocols are reported.

2) Results: The confusion matrix shown in Table 4 contains the mean and variance for all protocol parings. Again it is noted that it highly unlikely or impossible for the error to be zero as images are adjacent slices, not replicates as in S₁, implying that there will be slight visual differences. It can be seen that the DLSD approach consistently provides the smallest errors, implying that it is capable of reducing the difference in inter stain protocol settings.

TABLE 4
Confusion Matrix Showing Mean Errors with Variance Across 7 Protocols of 25
Images. (Lowest error for each group is bolded)

| | HE | ↑H↑E | ↓H↓E | ↓HE | H↓E | H↑E | ↑HE | |
|---|---|---|---|---|---|---|---|---|
| | N/A | 0.35 ± 0.02 | 0.43 ± 0.03 | 0.43 ± 0.03 | 0.45 ± 0.03 | 0.46 ± 0.03 | 0.54 ± 0.03 | Raw |
| | N/A | 0.09 ± 0.00 | 0.12 ± 0.00 | 0.12 ± 0.00 | 0.11 ± 0.00 | 0.11 ± 0.00 | 0.10 ± 0.00 | GL |
| | N/A | 0.05 ± 0.00 | 0.06 ± 0.00 | 0.05 ± 0.00 | 0.04 ± 0.00 | 0.04 ± 0.00 | 0.04 ± 0.00 | DLSD |
| | N/A | 0.07 ± 0.00 | 0.10 ± 0.00 | 0.10 ± 0.00 | 0.08 ± 0.00 | 0.09 ± 0.00 | 0.07 ± 0.00 | DM |
| | N/A | 0.41 ± 0.02 | 0.34 ± 0.02 | 0.37 ± 0.02 | 0.33 ± 0.02 | 0.35 ± 0.02 | 0.38 ± 0.02 | HS |
| | N/A | 0.35 ± 0.05 | 0.42 ± 0.03 | 0.42 ± 0.03 | 0.45 ± 0.03 | 0.45 ± 0.03 | 0.45 ± 0.03 | MM |
| | N/A | 0.48 ± 0.02 | 0.43 ± 0.03 | 0.43 ± 0.03 | 0.48 ± 0.02 | 0.47 ± 0.02 | 0.55 ± 0.02 | RH |
| ↑H↑E | 0.35 ± 0.02 | N/A | 0.39 ± 0.01 | 0.36 ± 0.01 | 0.29 ± 0.01 | 0.27 ± 0.01 | 0.25 ± 0.02 | Raw |
| | 0.28 ± 0.01 | N/A | 0.14 ± 0.00 | 0.12 ± 0.00 | 0.10 ± 0.00 | 0.10 ± 0.00 | 0.10 ± 0.00 | GL |
| | 0.17 ± 0.00 | N/A | 0.07 ± 0.00 | 0.07 ± 0.00 | 0.05 ± 0.00 | 0.05 ± 0.00 | 0.04 ± 0.00 | DLSD |
| | 0.28 ± 0.01 | N/A | 0.13 ± 0.00 | 0.12 ± 0.00 | 0.10 ± 0.00 | 0.10 ± 0.00 | 0.09 ± 0.00 | DM |
| | 0.31 ± 0.03 | N/A | 0.18 ± 0.02 | 0.17 ± 0.01 | 0.16 ± 0.01 | 0.15 ± 0.01 | 0.17 ± 0.02 | HS |
| | 0.96 ± 0.14 | N/A | 0.22 ± 0.01 | 0.22 ± 0.01 | 0.20 ± 0.02 | 0.20 ± 0.02 | 0.21 ± 0.02 | MM |
| | 0.31 ± 0.01 | N/A | 0.24 ± 0.01 | 0.24 ± 0.01 | 0.25 ± 0.01 | 0.24 ± 0.01 | 0.29 ± 0.01 | RH |
| ↓H↓E | 0.43 ± 0.03 | 0.39 ± 0.01 | N/A | 0.10 ± 0.01 | 0.19 ± 0.01 | 0.24 ± 0.01 | 0.41 ± 0.01 | Raw |
| | 0.33 ± 0.02 | 0.16 ± 0.01 | N/A | 0.10 ± 0.00 | 0.10 ± 0.00 | 0.10 ± 0.00 | 0.09 ± 0.00 | GL |
| | 0.28 ± 0.01 | 0.16 ± 0.01 | N/A | 0.03 ± 0.00 | 0.04 ± 0.00 | 0.05 ± 0.00 | 0.06 ± 0.00 | DLSD |
| | 0.34 ± 0.02 | 0.15 ± 0.01 | N/A | 0.07 ± 0.00 | 0.08 ± 0.00 | 0.08 ± 0.00 | 0.07 ± 0.00 | DM |
| | 0.37 ± 0.02 | 0.22 ± 0.02 | N/A | 0.12 ± 0.02 | 0.11 ± 0.01 | 0.15 ± 0.01 | 0.22 ± 0.03 | HS |
| | 1.04 ± 0.17 | 0.37 ± 0.18 | N/A | 0.09 ± 0.01 | 0.14 ± 0.01 | 0.16 ± 0.01 | 0.23 ± 0.02 | MM |
| | 0.38 ± 0.00 | 0.43 ± 0.00 | N/A | 0.32 ± 0.01 | 0.36 ± 0.00 | 0.34 ± 0.01 | 0.45 ± 0.00 | RH |
| ↓HE | 0.43 ± 0.03 | 0.36 ± 0.01 | 0.10 ± 0.01 | N/A | 0.14 ± 0.00 | 0.20 ± 0.00 | 0.39 ± 0.01 | Raw |
| | 0.34 ± 0.02 | 0.16 ± 0.01 | 0.11 ± 0.00 | N/A | 0.09 ± 0.00 | 0.09 ± 0.00 | 0.09 ± 0.00 | GL |
| | 0.27 ± 0.01 | 0.15 ± 0.01 | 0.06 ± 0.00 | N/A | 0.05 ± 0.00 | 0.05 ± 0.00 | 0.06 ± 0.00 | DLSD |
| | 0.34 ± 0.02 | 0.16 ± 0.01 | 0.10 ± 0.00 | N/A | 0.08 ± 0.00 | 0.08 ± 0.00 | 0.07 ± 0.00 | DM |
| | 0.39 ± 0.02 | 0.21 ± 0.02 | 0.11 ± 0.01 | N/A | 0.11 ± 0.01 | 0.11 ± 0.01 | 0.18 ± 0.01 | HS |
| | 1.02 ± 0.14 | 0.35 ± 0.17 | 0.10 ± 0.01 | N/A | 0.12 ± 0.00 | 0.15 ± 0.00 | 0.22 ± 0.01 | MM |
| | 0.36 ± 0.00 | 0.42 ± 0.00 | 0.29 ± 0.00 | N/A | 0.34 ± 0.00 | 0.32 ± 0.00 | 0.43 ± 0.01 | RH |
| H↓E | 0.45 ± 0.03 | 0.29 ± 0.01 | 0.19 ± 0.01 | 0.14 ± 0.00 | N/A | 0.11 ± 0.00 | 0.30 ± 0.01 | Raw |
| | 0.37 ± 0.02 | 0.18 ± 0.01 | 0.15 ± 0.00 | 0.13 ± 0.00 | N/A | 0.09 ± 0.00 | 0.09 ± 0.00 | GL |
| | 0.28 ± 0.01 | 0.15 ± 0.01 | 0.07 ± 0.00 | 0.06 ± 0.00 | N/A | 0.03 ± 0.00 | 0.04 ± 0.00 | DLSD |
| | 0.36 ± 0.02 | 0.18 ± 0.02 | 0.15 ± 0.00 | 0.13 ± 0.00 | N/A | 0.08 ± 0.00 | 0.08 ± 0.00 | DM |
| | 0.27 ± 0.02 | 0.22 ± 0.02 | 0.12 ± 0.01 | 0.11 ± 0.01 | N/A | 0.12 ± 0.01 | 0.20 ± 0.02 | HS |
| | 1.25 ± 0.14 | 0.36 ± 0.18 | 0.17 ± 0.00 | 0.16 ± 0.00 | N/A | 0.09 ± 0.00 | 0.17 ± 0.01 | MM |
| | 0.34 ± 0.00 | 0.36 ± 0.00 | 0.26 ± 0.01 | 0.26 ± 0.01 | N/A | 0.26 ± 0.01 | 0.36 ± 0.01 | RH |
| H↑E | 0.46 ± 0.03 | 0.27 ± 0.01 | 0.24 ± 0.01 | 0.20 ± 0.00 | 0.11 ± 0.00 | N/A | 0.28 ± 0.01 | Raw |
| | 0.37 ± 0.02 | 0.18 ± 0.01 | 0.15 ± 0.00 | 0.13 ± 0.00 | 0.10 ± 0.00 | N/A | 0.10 ± 0.00 | GL |
| | 0.27 ± 0.01 | 0.14 ± 0.01 | 0.07 ± 0.00 | 0.06 ± 0.00 | 0.03 ± 0.00 | N/A | 0.04 ± 0.00 | DLSD |
| | 0.36 ± 0.02 | 0.17 ± 0.01 | 0.14 ± 0.00 | 0.12 ± 0.00 | 0.08 ± 0.00 | N/A | 0.08 ± 0.00 | DM |
| | 0.32 ± 0.02 | 0.18 ± 0.02 | 0.14 ± 0.01 | 0.12 ± 0.01 | 0.11 ± 0.01 | N/A | 0.17 ± 0.02 | HS |
| | 1.24 ± 0.12 | 0.38 ± 0.20 | 0.21 ± 0.01 | 0.19 ± 0.00 | 0.09 ± 0.00 | N/A | 0.17 ± 0.01 | MM |
| | 0.31 ± 0.00 | 0.35 ± 0.00 | 0.23 ± 0.00 | 0.22 ± 0.00 | 0.26 ± 0.00 | N/A | 0.34 ± 0.00 | RH |
| ↑HE | 0.54 ± 0.03 | 0.25 ± 0.02 | 0.41 ± 0.01 | 0.39 ± 0.01 | 0.30 ± 0.01 | 0.28 ± 0.01 | N/A | Raw |
| | 0.38 ± 0.02 | 0.20 ± 0.02 | 0.17 ± 0.00 | 0.15 ± 0.00 | 0.11 ± 0.00 | 0.12 ± 0.00 | N/A | GL |
| | 0.28 ± 0.01 | 0.15 ± 0.02 | 0.09 ± 0.00 | 0.08 ± 0.00 | 0.05 ± 0.00 | 0.05 ± 0.00 | N/A | DLSD |
| | 0.38 ± 0.02 | 0.19 ± 0.02 | 0.16 ± 0.00 | 0.14 ± 0.00 | 0.10 ± 0.00 | 0.11 ± 0.00 | N/A | DM |
| | 0.27 ± 0.02 | 0.19 ± 0.02 | 0.15 ± 0.02 | 0.13 ± 0.01 | 0.14 ± 0.01 | 0.13 ± 0.01 | N/A | HS |
| | 1.50 ± 0.12 | 0.44 ± 0.26 | 0.27 ± 0.01 | 0.26 ± 0.01 | 0.16 ± 0.01 | 0.16 ± 0.01 | N/A | MM |
| | 0.29 ± 0.00 | 0.22 ± 0.01 | 0.22 ± 0.00 | 0.22 ± 0.00 | 0.18 ± 0.00 | 0.18 ± 0.00 | N/A | RH |

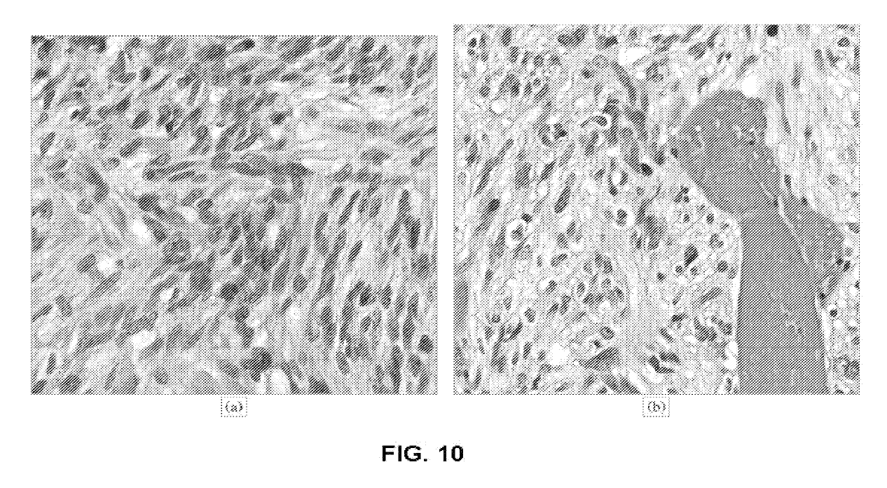

To qualitatively evaluate, the output from a subset is presented in FIG. 10, choosing specifically the most extreme of the images to normalize: ↓H↓E and ↑H↑E. It can be seen that although the stainings are notably different in the original images, the DLSD approach can successfully shift each image into the template images color space.

E. Experiment 3: Pipeline Enhancement

1) Design: Typically, normalization is not itself a terminal step, but instead is used as pre-processing in a larger pipeline with the intent of improving robustness. By using S₃, with its manual annotations, a simple pipeline is created to evaluate the effects of standardization. Two HE images were then selected to use as templates, as shown in FIG. 10, one which does not have any artifacts (see FIG. 10(a)) and one which does (see FIG. 10(b)). A color deconvolution was then performed using the HE stain matrix. Afterwards the optimal threshold was found (0.914 in this instance) on the template image, by which to separate the nuclei stained pixels from other pixels in the resultant H channel. The 7 images were normalized to the template images, and processed them in similar fashion: (a) color deconvolution followed by (b) thresholding. To evaluate the results, the Dice coefficient of the pixels was then computed as compared to the manually annotated ground truth for all approaches.

An HE image from dataset S₂ was chosen to act as the template image, but one in particular which does not have balanced class proportions. FIG. 10(b) shows this template image, as can be seen, the red blood cells on the right side of the image take up a large proportion of the image, while the rest of the staining is typical HE. This template was specifically selected to determine if the present method and the global method are robust against such inconsistencies. To provide a comparison, the template image shown in FIG. 10(a) does have class proportionality and is also missing any notable artifacts.

2) Results: As can be seen from the figures, the DLSD approach is capable of improving the Dice coefficient by 10% while reducing the variance. One of the difficulties with color deconvolution, is how the variability in images requires a unique deconvolution matrix for optimal results, with the process of finding one a non-trivial task. In this it will case, because seven different staining protocols were used, it is unlikely that the same matrix would work well for all of them. Instead, using the DLSD approach, a single template image is identified which works well and then the other images are shifted to that image. Further, by using its optimal operating parameters, better results are produced than both raw and global normalizations.

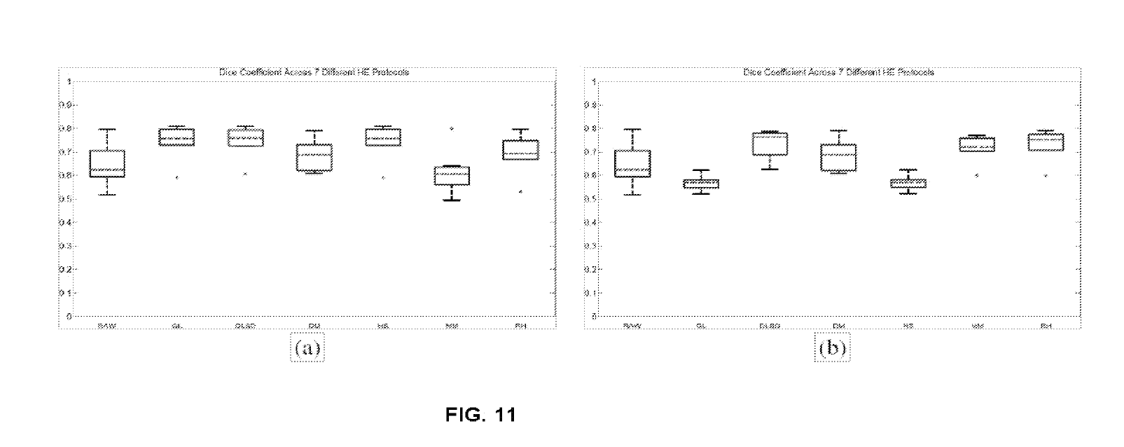

Analyzing each of the individual protocols separately, as shown in FIG. 11, the affects of the different protocols can be seen. As can be seen, the DL approach does not improve the HE image, which essentially makes sense because there is no improvement necessary. On the other hand, in the cases of ↑H and ↑H↑E significant improvements can be seen as a result of the normalization process. As expected, in all approaches, the global normalization does poorly because of the dissimilar balanced classes.

On the other hand, when the class proportions are respected, as can be seen in FIG. 11(a), the global normalization technique and the DLSD normalization technique perform similarly. As such, and considering the difference in computation time, it became of interest a way to quantitatively detect when either (a) no processing is necessary, (b) global normalization will succeed or (c) the more aggressive DLSD approach needs to be undertaken. In brief, a straightforward approach is discussed to determine when each approach should be used. It was found that the minimum cost using dynamic time warping (DTW) to compare the probability density function of the 128-binned histogram grayscale values of the template and moving image to be a suitable stratifier. In cases where the DLSD approach should be used, the minimum error found by DWT tends to be of an order of magnitude greater than images which are already normalized. Global normalization seems to work well when this error is twice the normalized error, indicating a wide threshold range for identifying which process should take place.

Conclusions: Normalization of digital histopathology images is reduces the variability and improve the robustness of algorithmic approaches further down the clinically diagnostic pipeline. In the present methodology a novel technique is provided which uses deep learned sparse auto encoding features, which optimally learn the best representation of the images, for this normalization process. Recognizing that these deep learned filters tend to be robust to staining and equipment differences, a feature space is created such that a standard k-means algorithm can produce suitable clusters, in an over-segmented manner. These over-segmented clusters can then be used to perform histogram equalization from the moving image to the template image, in a way which is resilient to outliers and produces limited visual artifacts.

Properties of the present approach were examined in three experiments. The first experiment showed that the approach can successfully compensate for inter- and intra-digital scanner differences. The second result provides both qualitative and quantative results showing the ability of the approach to handle differences arising from extreme staining protocol differences. Finally, in the third experiment, it was demonstrated that using the present methodology as a pre-processing step in other common approaches (such as color deconvolution), greatly reduces their variability and improves their robustness. In all cases, the present methodology performed as well or better than the current states of the art. As a result, this approach has the ability to be implemented in clinical systems with limited need for specific tuning and adjustments, making it a straightforward “out of the box” approach which can be used to combat histologic variability.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A method for processing histological images to improve color consistency, comprising the steps of:
providing image data for a histological image;
selecting a template image comprising image data corresponding to tissue in the histological image, wherein the template comprises a plurality of data subsets corresponding to different tissue classes in the template;
segmenting the image data for the histological image into a plurality of subsets, wherein the subsets correspond to different tissue classes;
constructing a histogram for each data subset of the template and constructing a histogram for the corresponding subset of the image data for the histological image;
aligning the histogram for each subset of the image data with the histogram of corresponding data subset of the template to create a series of standardized subsets of the image data; and
combining standardized subsets of the image data to create a standardized histological image.

2. The method of claim 1 wherein each subset of image data is divided into a plurality of color channels, wherein the step of constructing a histogram for each data subset comprises constructing a histogram for each color channel of each data subset of the template and constructing a histogram for the corresponding color channel of each subset of the image data for the histological image.

3. The method of claim 1 wherein the step of segmenting the image data for the histological image into a plurality of subsets comprises segmenting the image data using an expectation-maximization algorithm.

4. The method of claim 1 comprising the step of automatically segmenting the template into the plurality of data subsets by training an autoencoder to identify a plurality of tissue classes in a histological image.

5. (canceled)

6. The method of claim 4 wherein the step of automatically segmenting the template comprises training unsupervised deep learning filters using randomly selected subsets of the template image data.

7. The method of claim 6 wherein the step of training deep learning filters comprises training deep sparse autoencoders on the randomly selected subsets.

8. The method of claim 4 comprising the step of randomly selecting a plurality of subsets of image data from the template and using the subsets of image data during the step of training.

9-12. (canceled)

13. The method of claim 1 wherein the step of segmenting the image data for the histological image comprises the step of employing a standard k-means approach to identify a plurality of clusters centers.

14. The method of claim 13 wherein the step of segmenting comprises assigning image data into subsets based on the relation of the data to the cluster centers.

15. The method of claim 1 wherein the image data for the histological image is a two-dimensional set of pixels having color values in the Red, Green, Blue color space.

16. A method for processing histological images to improve color consistency, comprising the steps of:
providing image data for a histological image;
selecting a template corresponding to the histological image, wherein the template comprises a plurality of data subsets corresponding to different tissue classes in the template and each data subset is divided into a plurality of color channels;
segmenting the image data for the histological image into a plurality of subsets, wherein the subsets correspond to different tissue classes and each subset of image data is divided into a plurality of color channels;
comparing the histological image data of each color channel in a subset with the corresponding data subset of the corresponding color channel for the template;
selectively varying the histological image data of each color channel in a subset in response to the step of comparing to create a series of standardized subsets of the image data; and
combining standardized subsets of the image data to create a standardized histological image.

17. The method of claim 16 wherein each subset of image data is divided into a plurality of color channels, wherein the step of constructing a histogram for each data subset comprises constructing a histogram for each color channel of each data subset of the template and constructing a histogram for the corresponding color channel of each subset of the image data for the histological image.

18. The method of claim 16 wherein the step of segmenting the image data for the histological image into a plurality of subsets comprises segmenting the image data using an expectation-maximization algorithm.

19. The method of any of claims 16 comprising the step of automatically segmenting the template into the plurality of data subsets by training an autoencoder to identify a plurality of tissue classes in a histological image.

20. (canceled)

21. The method of claim 18 wherein the step of automatically segmenting the template comprises training unsupervised deep learning filters using randomly selected subsets of the template image data.

22. The method of claim 21 wherein the step of training deep learning filters comprises training deep sparse autoencoders on the randomly selected subsets.

23. The method of claim 21 comprising the step of randomly selecting a plurality of subsets of image data from the template and using the subsets of image data during the step of training.

24-27. (canceled)

28. The method of claim 16 wherein the step of segmenting the image data for the histological image comprises the step of employing a standard k-means approach to identify a plurality of clusters centers.

29. The method of claim 28 wherein the step of segmenting comprises assigning image data into subsets based on the relation of the data to the cluster centers.

30. (canceled)

31. A method for processing histological images to improve color consistency, comprising the steps of:
selecting a template histological image, wherein the template comprises a plurality of data subsets corresponding to different tissue classes in the template and each data subset is divided into a plurality of color channels;
randomly selecting a number of the data subsets;
training unsupervised deep learning filters on the randomly selected subsets;
applying the deep learning filters to a histological image to produce a set of filtered image data;
segmenting the filtered image data into a plurality of subsets;
comparing the filtered image data subsets with the corresponding data subset for the template;
selectively varying the histological image data of each color channel in a subset in response to the step of comparing to create a series of standardized subsets of the image data; and
combining standardized subsets of the image data to create a standardized histological image.

32. The method of claim 31 wherein the step of segmenting comprises the step of employing a standard k-means approach to identify a plurality of clusters centers.

33. The method of claim 32 wherein the step of segmenting comprises assigning image data into subsets based on the relation of the data to the cluster centers.

34. (canceled)

35. The method of claim 31 wherein the step of training deep learning filters comprises training deep sparse autoencoders on the randomly selected subsets.

36. The method of claim 31 comprising the step of denoising the auto-encoders by perturbing the randomly selected subsets with noise.
